(19) United States
(12) Patent Application Publication
(10) Pub. No.: US 2025/0218059 A1
(43) Pub. Date: Jul. 3, 2025

(54) IMAGE PROCESSING METHOD, APPARATUS, AND ELECTRONIC DEVICE

(71) Applicant: Lenovo (Beijing) Limited, Beijing (CN)

(72) Inventor: Qihua XIAO, Beijing (CN)

(21) Appl. No.: 18/951,570

(22) Filed: Nov. 18, 2024

(30) Foreign Application Priority Data
Dec. 29, 2023 (CN) 202311872964.0

(51) Int. Cl. G06T 11/00; G06F 16/33

(52) U.S. Cl. CPC G06T 11/00; G06F 16/3338

(57) ABSTRACT

An image processing method includes constructing a first image according to a first input content, processing a target image of the first image to obtain a first tag representing an image feature, expanding the first tag to obtain a second tag, and obtaining a second image at least according to the second tag. The first image includes at least one frame. A content amount of the second tag is greater than a content amount of the first tag, and the second tag includes a tag different from the first tag.

### CROSS REFERENCE TO RELATED APPLICATION

The present disclosure claims priority to Chinese Patent Application No. 202311872964.0, filed on Dec. 29, 2023, the entire content of which is incorporated herein by reference.

### TECHNICAL FIELD

The present disclosure is related to the image processing technology field and, more particularly, to an image processing method, an image processing apparatus, and an electronic device.

### BACKGROUND

Currently, an intelligent model often creates an image according to descriptive languages input by a user.

However, the descriptive language input by the user only represents general directions, and the image created by the intelligent model has a relatively large difference from user needs. Thus, the user needs to modify descriptive languages repeatedly, which causes a poor user experience when using the intelligent model to create the image.

### SUMMARY

One aspect of the present disclosure provides an image processing method. The method includes constructing a first image according to a first input content, processing a target image of the first image to obtain a first tag representing an image feature, expanding the first tag to obtain a second tag, and obtaining a second image at least according to the second tag. The first image includes at least one frame. The content amount of the second tag is greater than the content amount of the first tag, and the second tag includes a tag different from the first tag.

Another aspect of the present disclosure provides an image processing apparatus, including an image construction unit, a target processing unit, a tag expansion unit, and an image acquisition unit. The image construction unit is configured to construct a first image based on a first input content. The first image includes at least one frame. The target processing unit is configured to process a target image of the first image to obtain a first tag representing an image feature. The tag expansion unit is configured to expand the first tag to obtain a second tag. The content amount of the second tag is greater than the content amount of the first tag, and the second tag includes a tag different from the first tag. The image acquisition unit is configured to obtain a second image at least according to the second tag.

Another aspect of the present disclosure provides an electronic device including one or more processors and one or more memories. The one or more memories store a computer program that, when executed by the one or more processors, causes the one or more processors to construct a first image according to a first input content, process a target image of the first image to obtain a first tag representing an image feature, expand the first tag to obtain a second tag, and obtain a second image at least according to the second tag. The first image includes at least one frame. The content amount of the second tag is greater than the content amount of the first tag, and the second tag includes a tag different from the first tag.

### BRIEF DESCRIPTION OF THE DRAWINGS

FIG. 1 illustrates a schematic flowchart of an image processing method according to some embodiments of the present disclosure.

FIG. 2 illustrates a schematic structural diagram of an image processing apparatus according to some embodiments of the present disclosure.

FIG. 3 illustrates a schematic structural diagram of an electronic device according to some embodiments of the present disclosure.

FIG. 4 illustrates a schematic flowchart of generating a new image in a scenario of a user constructing an image through a text-to-image model according to some embodiments of the present disclosure.

FIG. 5 illustrates another schematic flowchart of generating a new image in a scenario of a user constructing an image through a text-to-image model according to some embodiments of the present disclosure.

### DETAILED DESCRIPTION OF THE EMBODIMENTS

The technical solutions of embodiments of the present disclosure are described in detail below in conjunction with the accompanying drawings of embodiments of the present disclosure. Apparently, the described embodiments are only some embodiments of the present disclosure and not all embodiments. Based on embodiments of the present disclosure, all other embodiments obtained by those skilled in the art without any creative effort are within the scope of the present disclosure.

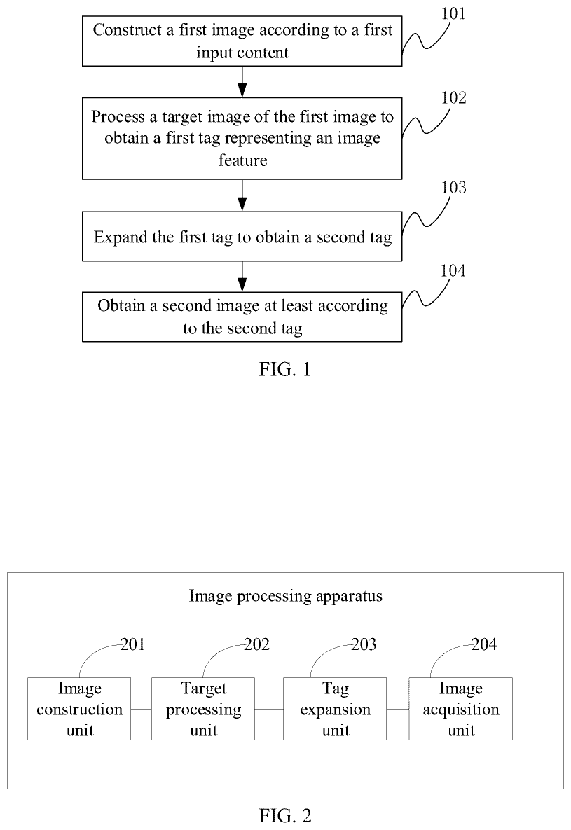

FIG. 1 illustrates a schematic flowchart of an image processing method according to some embodiments of the present disclosure. The method can be applied to an electronic device configured to perform image processing, such as a computer or a server. The technical solutions of embodiments of the present disclosure are mainly used to improve the user image configuration experience.

In some embodiments, the method includes the following steps.

At 101, a first image is constructed according to a first input content.

The first image can include at least one frame. The first input content can include an image, text, a keyword, or voice input by the user.

In some embodiments, a text-to-image model can be configured to process the first input content to generate at least one frame of the first image output by the text-to-image model.

The first images can include a same image feature or different image features.

At 102, a target image of the first images is processed to obtain a first tag representing an image feature.

In some embodiments, in step 102, the image feature of the target image can be identified to obtain the at least one first tag.

In some other embodiments, in step 102, the target image can be processed through the text-to-image model to obtain the at least one first tag corresponding to the target image.

The first tag can be a keyword or a descriptive sentence. One or more first tags can be provided.

The text-to-model can be configured to output an image according to input data (e.g., input content and/or tag) or according to an input image, e.g., a tag.

At 103, extension is performed according to the first tag to obtain a second tag.

The content amount of the second tag can be greater than the content amount of the first tag. The second tag can include a tag different from the first tag.

For example, the second tag can include all first tags and other tags different from the first tags.

At 104, a second image is obtained at least according to the second tag.

In some embodiments, in step 104, the second tag can be processed through the text-to-image model to obtain the second image output by the text-to-image model.

In some other embodiments, in step 104, image local adjustment can be performed on the target image or other first images according to the second tag to obtain the second image.

The second image can include more or more accurate image features compared to the first image to cause the second image to satisfy the user image configuration needs better compared to the first image.

Based on the above technical solution, in the image processing method of embodiments of the present disclosure, after the at least one frame of the first image is constructed according to the first input content, the target image of the first image can be processed to obtain a first tag representing the image feature. Then, after expansion is performed according to the first tag, the second tag with more content amount than the first tag and having tags different from the first tag can be obtained. Then, a new second image can be obtained according to the expanded second tag. Thus, based on the constructed image of embodiments of the present disclosure, the tag representing the image feature can be expanded, and the new image can be subsequently obtained according to the expanded tag. Thus, the feature in the image can be more accurate to better satisfy the detailed needs of the user and improve the user image configuration experience.

In some embodiments, in step 103, performing the expansion to obtain the second tag according to the first tag can include performing the expansion on the first tag according to the second input content to obtain the second tag.

The second tag can include tags different from the first tag and related to the second input content.

In some embodiments, the second input content can include images, text, keywords, and voice input by the user again. For example, in some embodiments, content identification, such as image identification, text identification, voice identification, and keyword identification, can be performed on the second input content to extract the expanded tag corresponding to the second input content. The expanded tag can represent the content in the second input content corresponding to the image feature. Then, a tag different from the first tag can be selected from the expanded tags. The selected tag can be integrated into the first tag to obtain the second tag. Thus, the second tag can include the first tag and the tag selected from the expanded tags.

In some embodiments, the tag different from the first tag can be selected according to a selection condition from the expanded tags. The selected tag can be different from the first tag and satisfy the selection condition. The selection condition can include the selected tag having content relevance with the first tag.

Thus, in some embodiments, the first tag can be expanded using the newly input content of the user to enrich the second tag used to obtain the second image to cause the image feature of the second image to be more accurate and satisfy the image configuration needs of the user.

Based on this, in step 104, obtaining the second image according to the second tag can include obtaining the second image according to the second tag and the first input content.

In some embodiments, in step 104, the second image can be constructed according to the second tag and the first input content. That is, the new image can be constructed according to the second tag and the first input content to obtain the second image.

For example, in step 104, the first input content can be modified using the second tag, e.g., image modification, keyword modification, and text modification, to obtain a new text.

Then, the image can be constructed again according to the new text through the text-to-image model to obtain the second image that is newly constructed.

For another example, in step 104, the image can be constructed again using the text-to-image model according to the second tag and the first input content to obtain the newly constructed second image.

In some other embodiments, in step 104, the image feature of the target image can be adjusted using the second tag and the first input content to obtain the second image.

For example, in step 104, the second tag can be used to perform feature modification on the image feature of the target image corresponding to the first input content. For example, the color of the lines or the size of the area can be modified to obtain a new target image, i.e., the second image.

Thus, in some embodiments, the second tag expanded by the newly input content of the user can be combined with the original content input by the user for image acquisition. Then, the image feature of the second image obtained based on the above can be more accurate to satisfy the user image configuration needs.

In some embodiments, the target image can be an image selected in the first image. Correspondingly, the first tag can represent the image feature of the selected target image.

Based on this, in step 103, performing the expansion according to the first tag to obtain the second tag can include performing the expansion on the first tag according to third tags corresponding to each frame of other frames of the first images to obtain the second tag.

The second tag can include a tag different from the first tag and related to the third tag.

Thus, the other frames of the first image can be images of the first image that are not selected. The third tag can be a tag obtained by processing each frame of the other frames of the first image. For example, the text-to-image model can be configured to perform processing on each frame of the other frames of the first image to obtain the third tag.

In some embodiments, the step 103 can be performed at least by one of the following methods.

In some embodiments, in step 103, a tag of the third tag different from the first tag can be added to the first tag to obtain the second tag.

In some other embodiments, in step 103, a tag of the third tag that is different from the first tag and has content relevance with the first tag can be added to the first tag to obtain the second tag. The content relevance can be understood as semantic content relevance. For example, a tag of the third tag that is different from the first tag but is related to comics as the first tag can be selected and added to the first tag to obtain the second tag.

In some other embodiments, in step 103, a new tag having the content relevance can be generated according to the tag of the third tag that is different from the first tag and has content relevance with the first tag. Then, the new tag can be added to the first tag to obtain the second tag. For example, another tag that is related to comics can be generated according to the tag of the third tag that is different from the first tag but is related to the comics as the first tag. The newly generated tag can be added to the first tag to obtain the second tag.

Thus, the first tag can be expanded by using a tag corresponding to other first images constructed in embodiments of the present disclosure to enrich the second tag, which is used to obtain the second image. Then, the image feature in the second image can be more accurate to satisfy the image configuration needs of the user.

Based on this, in step 104, obtaining the second image at least according to the second tag can include obtaining the second image according to the second input content and the second tag.

The second input content can include the images, text, keywords, and voices input by the user again.

In some embodiments, in step 104, the second image can be constructed according to the second tag and the second input content. That is, a new image can be constructed using the second tag and the second input content to obtain the second image.

For example, in step 104, content modification, such as adding descriptive phrases, modifying the image content, and modifying the text descriptive phrases, can be performed on the content newly input by the user by using the second tag. Then, the image construction can be performed through the text-to-image model using the new text to obtain the newly constructed second image.

For another example, in step 104, the image construction can be performed again directly using the text-to-image model according to the second tag and the second input content to obtain the second image that is newly constructed.

In some other embodiments, in step 104, the image feature of the target image can be adjusted according to the second tag and the second input content to obtain the second image.

For example, in step 104, the feature modification, such as color line or area size modification, can be performed on the image feature of the target image using the second tag and the second input content to obtain the new target image, i.e., the second image.

Thus, in some embodiments, the second tag that is expanded by the tag corresponding to the other images that are not selected can be combined with the content newly input by the user for image acquisition. Thus, the image feature of the second image obtained according to the above can be more accurate to satisfy the user image configuration needs.

In some other embodiments, in step 104, obtaining the second image at least according to the second tag can include obtaining the second image according to the second tag and the first input content.

In some embodiments, in step 104, the second image can be constructed according to the second tag and the first input content. That is, a new image can be constructed again using the second tag and the first input content to obtain the second image.

For example, in step 104, the first input content can be modified using the second tag. For instance, the image, the keyword, and the text can be modified to obtain the new text. Then, the image construction can be performed through the text-to-image model according to the new text to obtain the second image that is newly constructed.

For another example, in step 104, the text-to-image model can be directly configured to perform the image construction according to the second tag and the first input content to obtain the second image that is newly constructed.

In some other embodiments, in step 104, the image feature of the target image can be adjusted using the second tag and the first input content to obtain the second image.

For example, in step 104, the second tag can be applied. The feature modification, such as color line modification or area size modification, can be performed on the image feature of the target image corresponding to the first input content to obtain the new target image, i.e., the second image.

Thus, in some embodiments, the second tag that is expanded through the tag corresponding to the other non-selected images can be combined with the content originally input by the user for the image acquisition. Then, the image feature of the second image obtained based on this can be more accurate to satisfy the image configuration needs of the user.

In some embodiments, in step 103, performing the expansion according to the first tag to obtain the second tag can include performing the expansion on the first tag according to the first input content to obtain the second tag.

The second tag can include a tag different from the first tag and related to the first input content.

For example, in some embodiments, the content identification, such as image identification, text identification, voice identification, and keyword identification, can be performed on the first input content to extract the expansion tag corresponding to the first input content. The expansion tag can represent the content in the first input content corresponding to the image feature. Then, a tag different from the first tag can be selected from the expansion tag. The selected tag can be integrated into the first tag to obtain the second tag. Thus, the second tag can include the first tag and the tag selected from the expansion tag.

In some embodiments, the tag different from the first tag can be selected from the expansion tag according to the selection condition. The selected tag can be different from the first tag and satisfy the selection condition. The selected condition can include that the selected tag has content relevance with the first tag.

Thus, in some embodiments, the first tag can be expanded using the content that is originally input by the user to enrich the second tag used to obtain the second image. Thus, the image feature of the second image can be more accurate to satisfy the image configuration needs of the user.

Based on this, in step 104, obtaining the second image at least according to the second tag can include obtaining the second image according to the second tag and the second input content.

The second input content can include the images, text, keywords, and voices input by the user again.

In some embodiments, in step 104, the second image can be constructed according to the second tag and the second input content. That is, a new image can be constructed by using the second tag and the second input content to obtain the second image.

For example, in step 104, the content modification can be performed on the content that is newly input by the user using the second tag. For example, descriptive words can be added, image content can be modified, and text descriptive sentences can be modified. Then, the image construction can be performed through the text-to-image model using the obtained new text to obtain the newly constructed second image.

For another example, in step 104, the image can be constructed again directly using the text-to-image model according to the second tag and the second input content to obtain the newly constructed second image.

In some other embodiments, in step 104, the image feature of the target image can be adjusted using the second tag and the second input content to obtain the second image.

For example, in step 104, the feature modification, e.g., line color or area size modification, can be performed on the image feature corresponding to the target image according to the second tag and the second image content to obtain the target image, i.e., the second image.

Thus, in some embodiments, the second tag that is expanded through the content originally input by the user can be combined with the content that is newly input by the user for the image acquisition. Thus, the image feature of the second image that was obtained based on the above can be more accurate to satisfy the image configuration needs of the user.

FIG. 2 illustrates a schematic structural diagram of an image processing apparatus according to some embodiments of the present disclosure. The apparatus can be configured in an electronic device capable of image processing, such as a computer or a server. The technical solution of embodiments of the present disclosure is mainly used to improve the user image configuration experience.

In some embodiments, the apparatus includes an image construction unit 201, a target processing unit 202, a tag expansion unit 203, and an image acquisition unit 204.

The image construction unit 201 can be configured to construct the first image according to the first input content. The first image can include at least one frame.

The target processing unit 202 can be configured to process the target image in the first image to obtain the first tag that represents the image feature.

The tag expansion unit 203 can be configured to expand the first tag to obtain the second tag. The content amount of the second tag can be greater than the content amount of the first tag, and the second tag can include a tag different from the first tag.

The image acquisition unit 204 can be configured to obtain the second image at least according to the second tag.

According to the above technical solution, in the image processing apparatus of embodiments of the present disclosure, after the at least one frame of the first image is constructed according to the first input content, the target image of the first image can be processed to obtain the first tag representing the image feature. Then, after the expansion is performed according to the first tag, the second tag having the content amount greater than the first tag and including a label different from the first label can be obtained. The second image can be subsequently obtained according to the second label after the expansion. Thus, in some embodiments, based on the constructed image, the tag representing the image feature can be expanded, and a new image can be obtained according to the expanded tag. Thus, the features in the image can be more accurate, which can better satisfy the detail needs of the user and improve the image configuration experience.

In some embodiments, the tag expansion unit 203 can be configured to expand the first tag according to the second input content to obtain the second tag. The second tag can include a tag different from the first tag and having content relevance with the second input content.

In some embodiments, the target image can be a selected image in the first image. The tag expansion unit 203 can be configured to expand the first tag according to the third tag corresponding to each frame of other frames of the first image to obtain the second tag. The second tag can include the tag different from the first tag and related to the third tag.

In some embodiments, the tag expansion unit 203 can be configured to perform at least one of adding the tag of the third tag different from the first tag into the first tag to obtain the second tag, adding the tag of the third tag different form the first tag and having content relevance with the first tag into the first tag to obtain the second tag, or generating a new tag having content relevance according to the tag of the third tag different from the first tag and having the content relevance with the first tag, and add the new tag into the first tag to obtain the second tag.

Based on this, the image acquisition unit 204 can be configured to obtain the second image according to the second input content and the second tag.

In some other embodiments, the image acquisition unit 204 can be configured to obtain the second image according to the second tag and the first input content. The image acquisition unit 204 can be configured to perform at least one of constructing the second image according to the second tag and the first input content or adjusting the image feature of the target image according to the second tag and the first input content to obtain the second image.

In some embodiments, the tag expansion unit 203 can be configured to expand the first tag according to the first input content to obtain the second tag. The second tag can include a tag different from the first tag and related to the first input content.

For the implementation of the units of embodiments of the present disclosure, reference can be made to the relevant content of the above content, which is not repeated here.

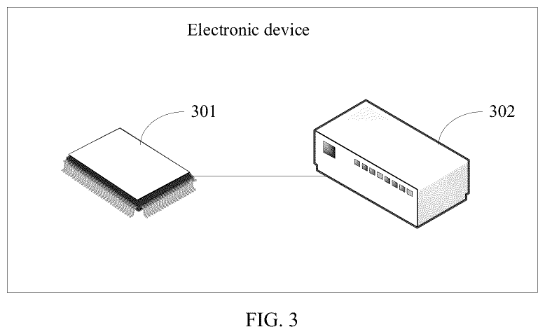

FIG. 3 illustrates a schematic structural diagram of an electronic device according to some embodiments of the present disclosure. The electronic device includes a memory 301 and a processor 302.

The memory 301 can be configured to store a computer program and data generated during the execution of the computer program.

The processor 302 can be configured to execute the computer program to construct the first image according to the first input content, the first image including at least one frame, process the target image in the first image to obtain the first tag representing the image feature, expanding the first tag to obtain the second tag, the content amount of the second tag being greater than the content amount of the first tag, and the second tag including the tag different from the first tag, and obtain the second image according to the second tag.

The electronic device can further include other structures, e.g., a communication bus, a display, and a communication module.

Based on the above technical solution, in the electronic device of embodiments of the present disclosure, after the at least one frame of the first image is constructed according to the first input content, the target image in the first image can be processed to obtain the first tag representing the image feature. Then, after expanding the first tag, the second tag having the content amount greater than the first tag can be obtained. Subsequently, the new second image can be obtained according to the second tag after the expansion. Thus, in some embodiments, based on the constructed image, the tag representing the image feature can be expanded. The new image can be obtained through the expanded label. Thus, the feature of the image can be more accurate, which can better satisfy the detail needs of the user and improve the user image configuration experience.

For example, in a scenario where a user uses a text-to-image model to construct an image, the technical solution of the present disclosure is described as follows.

First, when the image is generated, and after the user inputs a tag word “Prompt,” the corresponding image can be generated through the text-to-image model. Normally, 4 images can be generated for the user to select. Since “Prompt” only represents a general direction and does not fully understand the intentions of the user, a plurality of images can be generated for the user to select.

After the user selects one satisfactory image, continuous processing can be performed according to the image to generate a final solution. However, the image can only be used as reference, the algorithm does not include a mechanism to effectively understand the intention of the user.

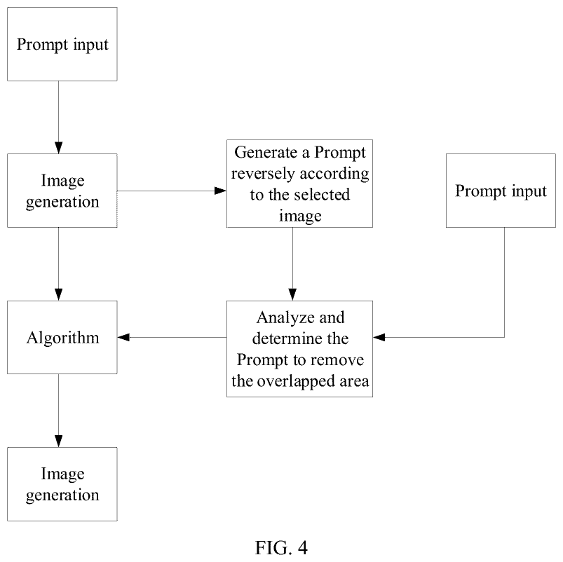

Thus, embodiments of the present disclosure provide a new image generation method. FIG. 4 illustrates a schematic flowchart of generating a new image in a scenario of a user constructing an image through a text-to-image model according to some embodiments of the present disclosure. The method includes the following processes.

First, the user inputs a Prompt.

Second, an image is generated according to the Prompt first input by the user, e.g., 3 or 4 frames.

Third, after the user selects one image from the 3 or 4 frames, feature analysis is performed on the image to generate a Prompt reversely according to the selected image.

Fourth, the user inputs a new Prompt.

Fifth, analysis can be performed according to the reversely generated Prompt and the new Prompt input by the user to determine and provide an overlapped Prompt to obtain an expanded Prompt.

Sixth, when the user inputs the selected image into the algorithm, the non-overlapped portion of the Prompt is modified in the combination with the expanded Prompt. That is, the original Prompt is modified.

Seventh, a plurality of images are generated according to the most newly obtained Prompt, i.e., the second image, for the user to select.

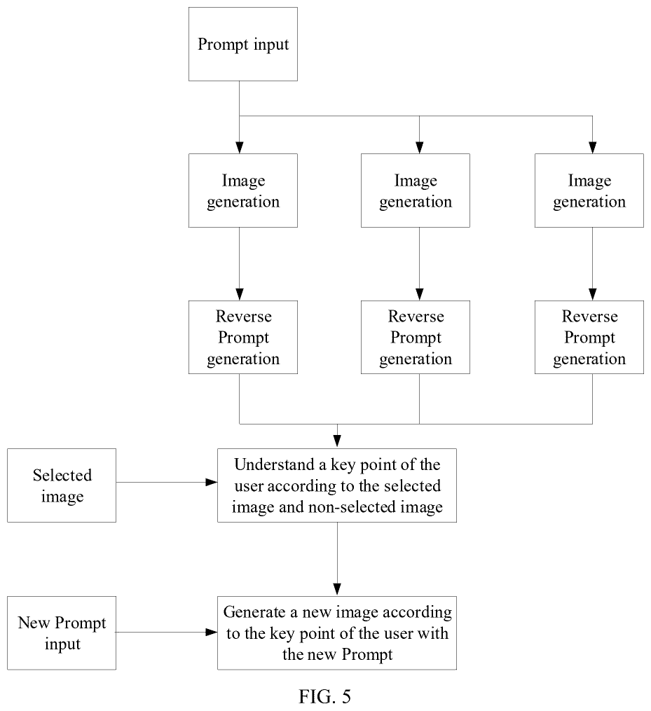

In some other embodiments, the present disclosure provides another new image generation method. FIG. 5 illustrates another schematic flowchart of generating a new image in a scenario of a user constructing an image through a text-to-image model according to some embodiments of the present disclosure. The method includes the following processes.

First, the user inputs a Prompt.

Second, four frames are generated according to the Prompt input by the user for the first time.

Third, one frame is selected.

Fourth, a reverse Prompt is generated according to the three non-selected images to generate a new Prompt.

Fifth, after the user selects one frame, analysis is performed on the selected image and the non-selected image to understand the key point of the user. That is, analysis and comparison are performed on the selected image and the non-selected image to extract the difference as an assistant Prompt. The main difference includes style and detail to form an assistant new supplemental Prompt.

Sixth, the user inputs a new Prompt again.

Seventh, according to the key points of the user, an image is generated in connection with the newly input Prompt and the new supplemental Prompt.

Thus, in the present disclosure, the Prompt can be expanded through the newly input Prompt and/or the Prompt reversely obtained through the generated image to understand the key point of the user by expanding the Prompt. Thus, the obtained image can better satisfy the image configuration needs of the user.

Embodiments of the present disclosure are described in a progressive manner. Each embodiment focuses on aspects different from other embodiments. The similar or identical parts of embodiments of the present disclosure can refer to each other. For the apparatus of embodiments of the present disclosure, since the apparatus corresponds to the method of embodiments of the present disclosure, the description is simple. For the relevant parts, reference can be made to the description of the method.

Those skilled in the art can further understand that units and algorithm steps of embodiments of the present disclosure can be implemented by electronic hardware, computer software, or a combination thereof. To describe the interchangeability of the hardware and the software, the composition and steps of embodiments of the present disclosure are described generally according to functionality. Whether the functions are executed by the hardware or the software depends on the application and designed restrictive condition of the technical solution. Those skilled in the art can realize the described function in different methods for the application, which should not be considered as exceeding the present disclosure.

The method or algorithm steps described in embodiments of the present disclosure can be implemented by hardware, software module executed by the processor, or a combination thereof. The software module can be stored in random access memory (RAM), memory, read-only memory (ROM), electrically programmable ROM, electrically erasable programmable ROM, registers, hard disks, removable disks, CD-ROMs, or any other form of storage medium known in the field.

The above description of embodiments of the present disclosure can enable those skilled in the art to implement or use the present disclosure. Various modifications of embodiments of the present disclosure are obvious to those skilled in the art. The general principle defined in the specification can be implemented in other embodiments without departing from the spirit or scope of the present disclosure. Thus, the present disclosure is not limited to the described embodiments of the specification but should be conform to the widest scope consistent with the principle and novel features of the present disclosure.

What is claimed is:

1. An image processing method comprising:
constructing a first image according to a first input content, the first image including at least one frame;
processing a target image of the first image to obtain a first tag representing an image feature;
expanding the first tag to obtain a second tag, a content amount of the second tag being greater than a content amount of the first tag, and the second tag including a tag different from the first tag; and
obtaining a second image at least according to the second tag.

2. The method of claim 1, wherein expanding the first tag to obtain the second tag includes:
expanding the first tag according to a second input content to obtain the second tag;
wherein the second tag includes a tag different from the first tag and related to the second input content.

3. The method of claim 1, wherein:
the target image is a selected image from the first image; and
expanding the first tag to obtain the second tag includes:
expanding the first tag according to a third tag corresponding to each frame of other frames of the first image to obtain the second tag;
wherein the second tag includes a tag different from the first tag and related to the third tag.

4. The method of claim 3, wherein expanding the first tag according to the third tag corresponding to each frame of the other frames of the first image to obtain the second tag includes at least one of:
adding a tag of the third tag that is different from the first tag into the first tag to obtain the second tag;
adding a tag of the third tag that is different from the first tag and has content relevance with the first tag into the first tag to obtain the second tag; or
generating a new tag having content relevance according to a tag of the third tag that is different from the first tag and has content relevance with the first tag, and adding the new tag into the first tag to obtain the second tag.

5. The method of claim 3, wherein obtaining the second image at least according to the second tag includes:
obtaining the second image according to the second input content and the second tag.

6. The method of claim 2, wherein obtaining the second image at least according to the second tag includes:
obtaining the second image according to the second tag and the first input content.

7. The method of claim 6, wherein obtaining the second image according to the second tag and the first input content includes at least one of:
constructing the second image according to the second tag and the first input content; or
adjusting the image feature of the target image according to the second tag and the first input content to obtain the second image.

8. The method of claim 1, wherein expanding the first tag to obtain the second tag includes:
expanding the first tag according to the first input content to obtain the second tag;
wherein the second tag includes a tag different from the first tag and related to the first input content.

9. An image processing apparatus comprising:
an image construction unit configured to construct a first image based on a first input content, the first image including at least one frame;
a target processing unit configured to process a target image of the first image to obtain a first tag representing an image feature;
a tag expansion unit configured to expand the first tag to obtain a second tag, a content amount of the second tag being greater than a content amount of the first tag, and the second tag including a tag different from the first tag; and
an image acquisition unit configured to obtain a second image at least according to the second tag.

10. The apparatus of claim 9, wherein the tag expansion unit is further configured to:
expand the first tag according to a second input content to obtain the second tag;
wherein the second tag includes a tag different from the first tag and related to the second input content.

11. The apparatus of claim 9, wherein:
the target image is a selected image from the first image; and
the tag expansion unit is further configured to:
expand the first tag according to a third tag corresponding to each frame of other frames of the first image to obtain the second tag;
wherein the second tag includes a tag different from the first tag and related to the third tag.

12. The apparatus of claim 11, wherein the tag expansion unit is further configured to perform at least one of:
adding a tag of the third tag that is different from the first tag into the first tag to obtain the second tag;
adding a tag of the third tag that is different from the first tag and has content relevance with the first tag into the first tag to obtain the second tag; or
generating a new tag having content relevance according to a tag of the third tag that is different from the first tag and has content relevance with the first tag, and adding the new tag into the first tag to obtain the second tag.

13. An electronic device comprising:
one or more processors; and
one or more memories storing a computer program that, when executed by the one or more processors, causes the one or more processors to:
construct a first image according to a first input content, the first image including at least one frame;
process a target image of the first image to obtain a first tag representing an image feature;
expand the first tag to obtain a second tag, wherein a content amount of the second tag being greater than a content amount of the first tag, and the second tag includes a tag different from the first tag; and
obtain a second image at least according to the second tag.

14. The device of claim 13, wherein the one or more processors are further configured to:
expand the first tag according to a second input content to obtain the second tag;
wherein the second tag includes a tag different from the first tag and related to the second input content.

15. The device of claim 13, wherein:
the target image is a selected image from the first image; and
the one or more processors are further configured to:
expand the first tag according to a third tag corresponding to each frame of other frames of the first image to obtain the second tag;
wherein the second tag includes a tag different from the first tag and related to the third tag.

16. The device of claim 15, wherein the one or more processors are further configured to perform at least one of:
adding a tag of the third tag that is different from the first tag into the first tag to obtain the second tag;
adding a tag of the third tag that is different from the first tag and has content relevance with the first tag into the first tag to obtain the second tag; or
generating a new tag having content relevance according to a tag of the third tag that is different from the first tag and has content relevance with the first tag, and adding the new tag into the first tag to obtain the second tag.

17. The device of claim 15, wherein the one or more processors are further configured to:
obtain the second image according to the second input content and the second tag.

18. The device of claim 10, wherein the one or more processors are further configured to:
obtain the second image according to the second tag and the first input content.

19. The device of claim 18, wherein the one or more processors are further configured to perform at least one of:
constructing the second image according to the second tag and the first input content; or
adjusting the image feature of the target image according to the second tag and the first input content to obtain the second image.

20. The device of claim 13, wherein the one or more processors are further configured to:
expand the first tag according to the first input content to obtain the second tag;
wherein the second tag includes a tag different from the first tag and related to the first input content.
